(19) United States
(12) Patent Application Publication
(10) Pub. No.: US 2002/0109664 A1
(43) Pub. Date: Aug. 15, 2002

(54) Display apparatus and an image processing apparatus

(76) Inventor: Masaki Shimada, Tokyo (JP)

Correspondence Address: Donald C. Lucas, Bierman, Muserlian and Lucas, 600 Third Avenue, New York, NY, 10016, US

(21) Appl. No.: 10/122,889

(22) Filed: Apr. 15, 2002

Related U.S. Application Data
(62) Division of application No. 09/501,402, filed on Feb. 10, 2000.

(30) Foreign Application Priority Data
Feb. 19, 1999 (JP) 041339/1999

(51) Int. Cl. G09G 3/36

(52) U.S. Cl. 345/102

(57) ABSTRACT

A display apparatus which includes an illuminator for irradiating, a display being capable of displaying by using light irradiated by the illuminator, a sensor for detecting brightness of the outside, and a controller for controlling luminous intensity of the illumination in accordance with the results of detection by the sensor.

### BACKGROUND OF THE INVENTION

The present invention relates to a display apparatus, and in particular, to a display apparatus such as a liquid crystal monitor (liquid crystal display) used in a personal computer, a video camera, a digital still camera and a portable television set.

In the field of a personal computer, a video camera, a digital still camera and a portable television set, it has been made popular to use a liquid crystal monitor and thereby to make a structure to be light and compact. Incidentally, in the case of CRT used in a large-sized television set for displaying images equally, displayed images can be observed without requiring auxiliary illumination even when the outside is dark, because a cathode-ray tube itself emits light.

However, in the case of a liquid crystal monitor, when observing images displayed on the liquid crystal monitor, it has been necessary either to irradiate a screen to observe reflected light or to irradiate a screen from its rear side to observe transmitted light, because the liquid crystal monitor does not usually emit light by itself. Therefore, it has been necessary to provide some kinds of auxiliary illumination means for observing images on the liquid crystal monitor.

When an auxiliary illumination means of this kind is provided, however, the following problems are caused. Namely, in the case of a digital still camera provided with a liquid crystal monitor, it is arranged in a way that various functions of the digital still camera may be exhibited by electric power of a built-in battery, so that the digital still camera may also be used outdoors. Therefore, when the digital still camera is used outdoors, the liquid crystal monitor is also operated by electric power of the battery, in which, however, the liquid crystal monitor does not consume power so much (for example, power consumption is 0.3 W).

However, as an auxiliary illumination means which illuminates a liquid crystal monitor, for example, a method of using a build-in lamp is popular; however, the lamp usually consumes great power (for example, 1.5 W) which is about 5 times that of a liquid crystal monitor, and this power consumption is equivalent to ½-¼ of the total power consumption of a digital still camera. Accordingly, when images are reproduced by the liquid crystal monitor while the light is lit, a battery runs down quickly, and thereby, image reproduction and image pickup become impossible. Therefore, a user is required to replace a battery or to give a charge of electricity to a battery frequently, which is time-consuming.

On the other hand, there is a liquid crystal monitor so called such as “reflection type” or “daylight type” in which light from an external light source such as sunlight or an indoor lamp is used. In such monitor, if sunlight or indoor lamp exists, illumination by light which serves as an auxiliary illumination means is not needed, which makes it desirable to turn off the light according to circumstances from the viewpoint of power saving. However, if an on-off switch for the light is provided so that a user may switch at need, there are caused problems that operation is complicated and a battery runs down quickly because of failure to turn off.

Further, in the case of the so-called state of rear light wherein an external light source such as sunlight exists in the direction of eyes of an observer, it is necessary to have the liquid crystal display irradiated with light in the occasion of observing a reflection type liquid crystal monitor, for example, separately from the problem of the auxiliary illumination means, there is a problem that an image displayed on a screen of the liquid crystal monitor is hard to be observed because the circumferential light is brighter than the light irradiated to the screen and reflected from the built-in reflection panel.

Further, when the liquid crystal monitor is of “daylight type”, it is necessary to have the screen surface irradiated with strong light; therefore, the location of the outside light source becomes important.

### SUMMARY OF THE INVENTION

In view of the aforesaid problems in prior art, an object of the invention is to provide a display apparatus and an image processing apparatus wherein power consumption can be reduced and displayed images can be made easier to observe.

The invention attaining the object stated above is represented by the following.

(1) A display apparatus comprising:

an illumination means for irradiating light;

a display being capable of displaying by using light irradiated by the illumination means;

a sensor for detecting brightness of the outside; and

a controller which controls luminous intensity of the illumination means based on the results of detection by the sensor.

(2) The display apparatus according to (1) wherein the controller controls the illumination means so that it may irradiate when the controller judges, based on the results of detection conducted by the sensor, that brightness of the outside is less than the first prescribed value.

(3) The display apparatus according to (1) wherein the controller controls luminous intensity of the illumination means so that the luminous intensity of the illumination means may be inversely proportional to brightness of the outside, when the controller judges that brightness of the outside is less than the first prescribed value based on the results of detection conducted by the sensor.

(4) The display apparatus according to (1) wherein the controller controls luminous intensity of the illumination means so that the luminous intensity of the illumination means may be lower than that in the occasion where brightness of the outside is the second prescribed value, when the controller judges that brightness of the outside is less than the second prescribed value based on the results of detection conducted by the sensor.

(5) The display apparatus according to (1) wherein the controller has a first photometric sensor and a second photometric sensor which is provided at a position that is physically different from that of the first photometric sensor, and the controller controls luminous intensity of the illumination means based on results of photometry conducted by the first and second photometric sensors.

(6) The display apparatus according to (1) wherein the sensor is an image pickup element.

(7) The display apparatus according to (6) wherein the controller judges, based on output signals form the image pickup element, whether an object which is subjected to image pickup by the image pickup element is in the state of rear light or not, and controls the illumination means so that the illumination means may irradiate, when the controller judges that the object is in the state of rear light.

(8) The display apparatus according to (6) wherein the controller controls luminous intensity of the illumination means so that the luminous intensity of the illumination means may be lower than that in the occasion where brightness of the outside is a prescribed value, when the controller judges that brightness of the outside is less than the prescribed value, based on the results of detection by the sensor.

(9) The display apparatus according to (5) wherein the controller judges, based on detection results of the first and second photometric sensors, whether the display is in the state of rear light or not, and controls the illumination means so that the illumination means may irradiate, when the controller judges that the display is in the state of rear light.

(10) The display apparatus according to (1) wherein the display is a liquid crystal display which is capable of displaying by using light of the outside.

(11) The display apparatus according to (7) wherein a position sensor for detecting the positional relationship between the image pickup element and the display is provided, and the controller judges, based on detection results of the position sensor and the image pickup element, whether an object which is subjected to image pickup by the image pickup element is in the state of rear light or not, and controls the illumination means so that the illumination means may irradiate, when the controller judges that the object is in the state of rear light.

(12) An image processing apparatus comprising:

an image pickup element which obtains image data by transforming optical information into electric signals;

a setting means which sets exposure conditions;

a memory which stores image data obtained from the image pickup element;

an illumination means for irradiating;

a display being capable of displaying an image corresponding to image data obtained directly from the image pickup element or stored in the memory by using light irradiated by the illumination means; and

a controller which controls luminous intensity of the illumination means by judging the state of the outside based on image data obtained from the image pickup element and on the exposure conditions established by the setting means.

(13) The image processing apparatus according to (12) wherein the controller controls luminous intensity of the illumination means by obtaining image data from the image pickup element, when the display means displays corresponding images based on image data stored in the memory.

(14) The image processing apparatus according to (12) wherein the display is a liquid crystal display which is capable of displaying by using light of the outside.

(15) The image processing apparatus according to (12) wherein a position sensor for detecting the positional relationship between the image pickup element and the display is provided, and the controller judges, based on detection results of the position sensor and the image pickup element, whether an object which is subjected to image pickup by the image pickup element is in the state of rear light or not, and controls the illumination means so that the illumination means may irradiate, when the controller judges that the object is in the state of rear light.

(16) The display apparatus according to (3), wherein the controller controls luminous intensity of the illumination means so that the luminous intensity of the illumination means is proportional to brightness of the outside when the controller judges that brightness of the outside is less than a second predetermined value in accordance with the results of detection by the sensor, the second predetermined value being less than the first predetermined value.

(17) The display apparatus according to (1), wherein the controller controls the illumination means so as to irradiate when the display is in a state of rear light.

(18) The display apparatus according to (10), wherein the display has guide means for guiding light of the outside to a liquid crystal of the display or reflecting means for reflecting light of the outside and guide to the liquid crystal of the display.

(19) The display apparatus according to (2), wherein the display is a liquid crystal display which is capable of displaying by using light of the outside.

(20) The display apparatus according to (19), wherein the display has guide means for guiding light of the outside to a liquid crystal of the display or reflecting means for reflecting light of the outside and guide to the liquid crystal of the display.

(21) The display apparatus of according to (6), wherein the controller controls luminous intensity of the illumination means so that the luminous intensity of the illumination means is inversely proportional to brightness of the outside when the controller judges that brightness of the outside is less than a first predetermined value in accordance with the results of detection by the image pickup element.

(22) The display apparatus according to (21), wherein the controller controls luminous intensity of the illumination means so that the luminous intensity of the illumination means is proportional to brightness of the outside when the controller judges that brightness of the outside is less than a second predetermined value in accordance with the results of detection by the image pickup element, the second predetermined value being less than the first predetermined value.

(23) The display apparatus according to (1), wherein the controller controls luminous intensity of the illumination means so that the luminous intensity of the illumination means is proportional to brightness of the outside when the controller judges that brightness of the outside is less than a second predetermined value in accordance with the results of detection by the sensor.

(24) The image processing apparatus according to (14), wherein the display has guide means for guiding light of the outside to a liquid crystal of the display or reflecting means for reflecting light of the outside and guide to the liquid crystal of the display.

(25) A camera comprising:

a display for displaying;

an illumination means for irradiating the display;

a sensor for detecting brightness of the outside; and

a controller which controls luminous intensity of the illumination means based on detection results of the sensor.

(26) A camera comprising:

an image pickup element for obtaining image data by transforming optical information into electric signals;

a setting means for setting exposure conditions;

a memory for storing image data obtained from the image pickup element;

a display for displaying corresponding images based on image data obtained directly from the image pickup element or on image data stored in the memory;

an illumination means for illuminating the display; and

a controller which controls luminous intensity of the illumination means by judging the state of the outside based on image data obtained from the image pickup element and on exposure conditions established by the setting means.

There further are the following as a preferable structure related to the display apparatus of the invention.

(1) A display apparatus comprising:

a display means which displays by using illumination of an illumination means when the outside is dark;

a sensor means which detects brightness of the outside; and

a control means which controls luminous intensity of the illumination means based on detection results of the sensor means.

(2) The display apparatus according to (1) wherein the control means starts illumination of the illumination means when it judges that brightness of the outside is not more than the first prescribed value based on detection results of the sensor means.

(3) The display apparatus according to (1) or (2) above, wherein the control means increases luminous intensity of the illumination means in inverse proportion to brightness of the outside, when the control means judges that brightness of the outside is not more than the first prescribed value based on detection results of the sensor means.

(4) The display apparatus according to (1)-(3) above, wherein the control means lowers luminous intensity of the illumination means more than the occasion where brightness of the outside exceeds the second prescribed value, when the control means judges that brightness of the outside is not more than the second prescribed value, based on detection results of the sensor means.

(5) The display apparatus according to (1)-(4) above, wherein the sensor means the sensor means has therein the first photometric sensor and the second photometric sensor which is provided at the location which is physically different from that for the first photometric sensor, and the control means controls luminous intensity of the illumination means based on photometry results of the first and second photometric sensors.

(6) The display apparatus according to (1)-(5) above, wherein the sensor means is an image pickup element.

(7) The display apparatus according to (6) above, wherein the control means judges whether an object subjected to image pickup by the image pickup element is in the state of rear light or not, based on output signals from the image pickup element, and starts illumination of the illumination means when the control means judges that the object is in the state of rear light.

(8) The display apparatus according to (6)-(7) above, wherein the control means lowers luminous intensity of the illumination means more than the occasion where brightness of the outside exceeds a prescribed value, when the control means judges that brightness of the outside is not more than a prescribed value, based on detection results of the sensor means.

There further are the following as a preferable structure relating to an image processing apparatus of the invention.

(9) An image processing apparatus comprising:

an image pickup element;

a setting means which establishes exposure conditions;

a memory which stores image data obtained from the image pickup element;

a display means which displays corresponding images based on image data obtained directly from the image pickup element or based on image data stored in the memory;

an illumination means which supplies illumination for display to the display means when the outside is dark; and

a control means which judges the-state of the outside based on image data obtained from the image pickup element and on exposure conditions established by the setting means, and controls luminous intensity of the illumination means.

(10) The image processing apparatus according to (9) above, wherein the control means controls luminous intensity of the illumination means by obtaining image data from the image pickup element, when the display means displays corresponding images based on image data stored in the memory.

In the display apparatus of the invention, when the outside is bright, it is possible to prevent failure of a user to turn off and thereby to attain electric power saving by lowering luminous intensity of an illumination means automatically depending on brightness, or by stopping illumination, while when the outside is dark, it is possible to enhance visibility of display by increasing luminous intensity of an illumination means automatically, or by starting illumination.

Further, in the invention, if an arrangement is made so that the sensor means has a first photometric sensor and a second photometric sensor which is provided at the location differing physically from that for the first photometric sensor, and the control means controls luminous intensity of the illumination means based on photometry results of the first and second photometric sensors, it is possible to attain electric power saving by stopping illumination of the illumination means when a screen is directly irradiated by light from an external light source at visible brightness, for example, and it is possible to enhance visibility by starting illumination of the illumination means when a back side of the screen is irradiated by light from the external light source.

Further, when the outside is dim as in the case of twilight, for example, visibility of display is worsened if luminous intensity is not increased to a certain extent, but when the outside is as dark as pitch as in the case of a moonless night, it sometimes happens that visibility can be secured even when luminous intensity of the illumination means is lowered slightly. Therefore, when the control means judges that the outside is considerably dark (brightness is not more than the second prescribed value) based on detection results of the sensor means, it is possible to attain electric power saving while securing visibility of display, by lowering luminous intensity of the illumination means more than the case where the outside is dim (brightness is exceeding the second prescribed value).

Further, the image processing apparatus of the invention has therein an image pickup element, a setting means which establishes exposure conditions, a memory which stores image data obtained from the image pickup element, a display means which displays corresponding images based on image data obtained directly from the image pickup element or on image data stored in the memory, an illumination means which supplies illumination for display to the display means when the outside is dark, and a control means which judges the state of the outside based on image data obtained from the image pickup element and on exposure conditions established by the setting means. Therefore, in the case of an image processing apparatus such as a digital still camera and a video camera, for example, it is possible to judge the state of the outside based on image data of an image pickup element and exposure conditions (aperture value and shutter speed), without providing a separate photometric sensor, and thereby to control starting and stopping of illumination of the illumination means, while, CPU serving as the control means can judge whether an object subjected to image pickup by the image pickup element is in the state of rear light or not based on image data from the image pickup element. Thus, if the object is in the state of rear light, it is possible to improve visibility for display by starting illumination of the illumination means.

When the display means stated above is used in an image processing apparatus which is powered by a battery, in particular, and reproduces images based on image data obtained from the image pickup element, the display means can enhance an effect of electric power saving in the apparatus.

### BRIEF DESCRIPTION OF THE DRAWINGS

FIG. 1 is a diagram showing a laptop personal computer related to the first embodiment of the invention.

FIG. 2 is a diagram showing a control apparatus for a light in the personal computer shown in FIG. 1.

FIG. 3 (a) is a flowchart showing control operations of CPU 14, and each of FIG. 3(b) and FIG. 3(c) is a graph showing luminous intensity of light 16 which is controlled based on the flowchart stated above for the measured brightness of the outside.

FIG. 4 is a block diagram showing a variation of the first embodiment.

FIG. 5(a) is a flowchart showing control operations of CPU 24, and each of FIG. 5(b) and FIG. 5(c) is a graph showing luminous intensity of light 26 which is controlled based on the flowchart stated above for the measured brightness of the outside.

FIG. 6(a) is a flowchart showing control operations in another variation, and each of FIG. 6(b) FIG. 6(d) is a graph showing luminous intensity of a light which is controlled based on the flowchart stated above for the measured brightness of the outside.

FIG. 7 is a diagram showing a laptop personal computer related to the second embodiment of the invention.

FIG. 8 is a diagram showing a control apparatus for a light in the personal computer shown in FIG. 7.

FIG. 9(a) is a flowchart showing control operations in the second embodiment, and each of FIG. 9(b) and FIG. 9(c) is a graph showing luminous intensity of a light which is controlled based on the flowchart stated above for the measured brightness of the outside.

FIG. 10 is a block diagram showing the structure of a digital still camera serving as an image processing apparatus related to the third embodiment.

FIG. 11 is a diagram showing the flowchart which shows control operations of light driving circuit 111.

FIG. 12 is a flowchart showing a variation of control operations of the light driving circuit 111.

FIG. 13 is a diagram showing an object which is subjected to image pickup by a digital camera together with an image plane.

FIG. 14 is a diagram showing positional relationship between an image pickup plane of CCD and a display surface of LCD.

FIG. 15 is a diagram showing a digital camera wherein an image pickup optical system and a display means rotate on the same axis of rotation.

FIG. 16 is a diagram showing a detection method for rear light and front-light.

FIG. 17 is a diagram showing a concrete example of the detection method shown in FIG. 16.

FIG. 18 is a diagram showing a method to control an illumination means by an angle formed between image pickup space and display space.

### DETAILED DESCRIPTION OF THE INVENTION

An embodiment of the invention will be explained as follows, referring to the drawings.

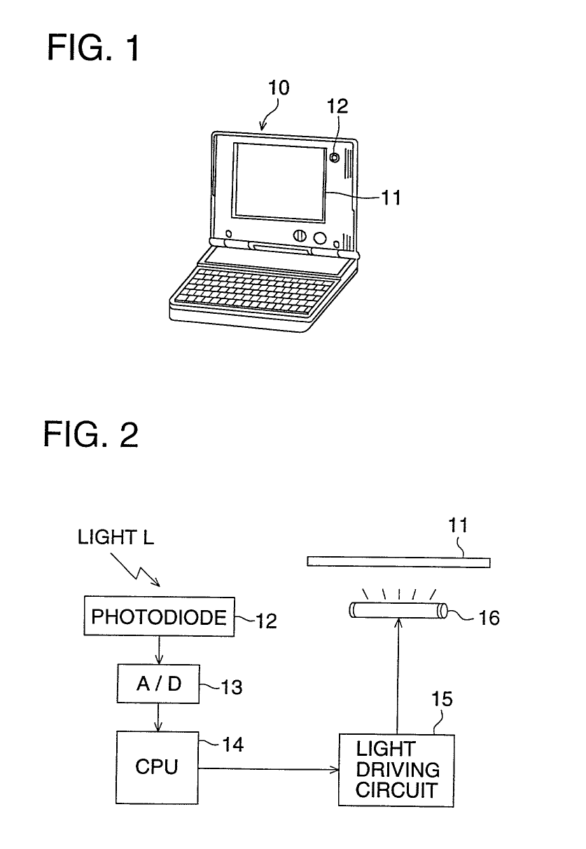

FIG. 1 is a diagram showing a laptop personal computer related to the first embodiment of the invention. In FIG. 1, personal computer 10 serving as an image processing apparatus has therein reflection type liquid crystal monitor 11 (a liquid crystal monitor capable of being viewed with external light without a help of a light when intensity of the external light is high) to display an image as a display, and photodiode 12 representing a sensor means which is adjacent to the right side on the upper portion of the liquid crystal monitor 11. On the liquid crystal monitor 11 representing a display means, there is arranged built-in light 16 for illumination.

Though an example of a reflection type liquid crystal monitor (the type of reflecting light, irradiated to the side such as of displaying an image, with a reflector panel so as to irradiate the reflected light to liquid crystal portion) is explained in the present embodiment, the invention also applies to a liquid crystal monitor of a daylight-backlight type which uses outside light (the type of taking in outside light to light guide panel or the like so as to irradiate it to liquid crystal portion).

FIG. 2 is a diagram showing a control apparatus for a light in the personal computer shown in FIG. 1. In FIG. 2, light 16 is arranged on the edge of the liquid crystal monitor 11 so that the light 16 may irradiate the liquid crystal monitor 11 at need based on electric power supplied from light driving apparatus 15.

In FIG. 2, photodiode 12 which receives outside light L outputs analog signals which are proportional to the intensity of the outside light to A/D converter 13. The A/D converter 13 converts the inputted analog signals into digital signals, and outputs them to CPU 14. The CPU 14 representing a control means is arranged to control light driving apparatus 15 through a mode explained below.

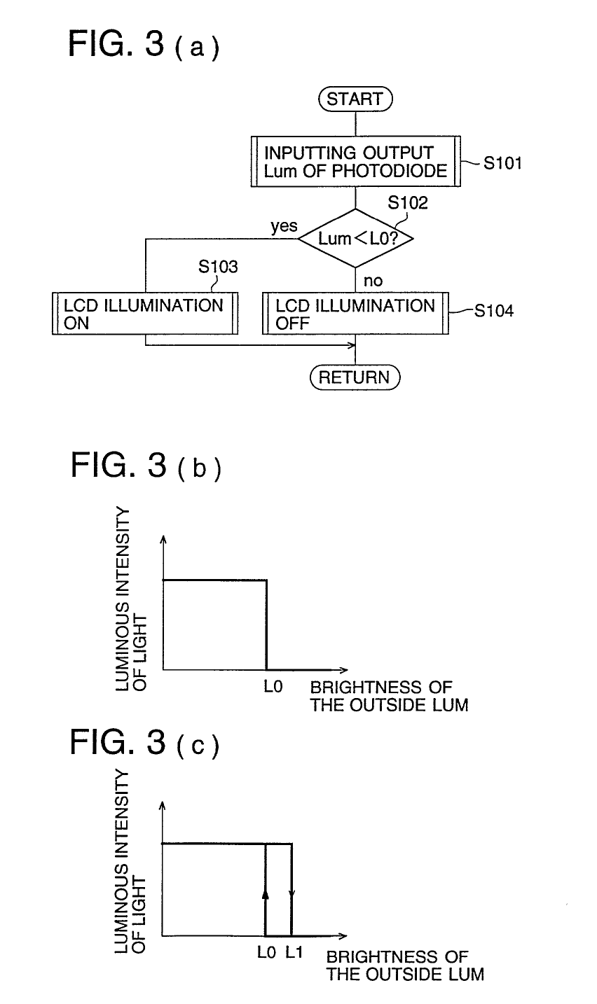

FIG. 3(a) is a flowchart showing control operations of the CPU 14. This flowchart is executed periodically as a subroutine of the CPU 14. Upon the start of the subroutine, output signal value Lum from photodiode 12 is inputted first in the CPU 14 in step S101. Further, in step S102, the CPU 14 compares the output signal value Lum with L0 representing a standard value. The standard value L0 is a value corresponding to brightness which makes it difficult to view an image displayed on liquid crystal monitor 11 without light 26 if the outside becomes more dark, and it is about 700 lux in an ordinary personal computer. The standard value L0 of this kind can be stored in CPU 14 as a default value in advance.

When the output signal value Lum is smaller than the standard value L0, the CPU 14 judges that it is difficult to view the liquid crystal monitor 11 because of the outside which is dark, then it transmits energizing signals to light driving apparatus 15 in step S103, and turns on light 16 to end a subroutine. Due to this, the liquid crystal monitor 11 is illuminated by light 16, and a user can view the displayed image easily.

On the other hand, in step S102, when the output signal value Lum is the standard value L0 or more, the CPU 14 judges that the outside is bright enough to secure the visibility, then it transmits de-energizing signals to light driving apparatus 15 in step S104, and turns off light 16 to end a subroutine.

FIG. 3(b) is a graph showing luminous intensity of light 16 which is controlled based on the flowchart stated above for the measured brightness of the outside. Incidentally, as shown in FIG. 3(c), if the so-called hysteresis wherein light 16 is turned off when brightness of the outside becomes value L1 which exceeds value L0 is given to the control, it is possible to enhance visibility for a user who actually observes images. Since the method to give hysteresis is widely known, the details will not be described here.

In the present embodiment, as stated above, when the outside becomes dark, CPU 14 judges this and light 16 is automatically turned off. Therefore, visibility of display on a liquid crystal monitor can be improved. When the outside becomes bright, CPU 14 judges this and turns off light 16 automatically. Thus, it is possible to attain electric power saving. Moreover, it is not necessary for a user to operate a specific switch when turning a light on and off, which makes handling to be more excellent.

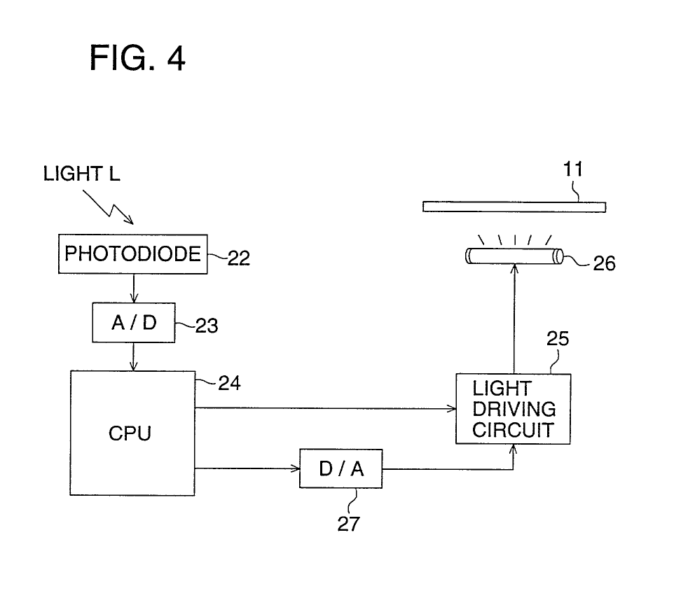

FIG. 4 is a block diagram showing a variation of the first embodiment. A difference between this variation and the first embodiment is that D/A converter 27 is arranged between CPU 24 and light driving circuit 25, and control signals according to output signal Lum 1 of photodiode 22 are transmitted from CPU 24 to light driving circuit 25 through the D/A converter 27. The light driving circuit 25 into which the control signal is inputted is arranged to be capable of adjusting luminous intensity of light 26 according to the control signal. Since other structures are the same as those in the first embodiment, explanation therefor will be omitted here.

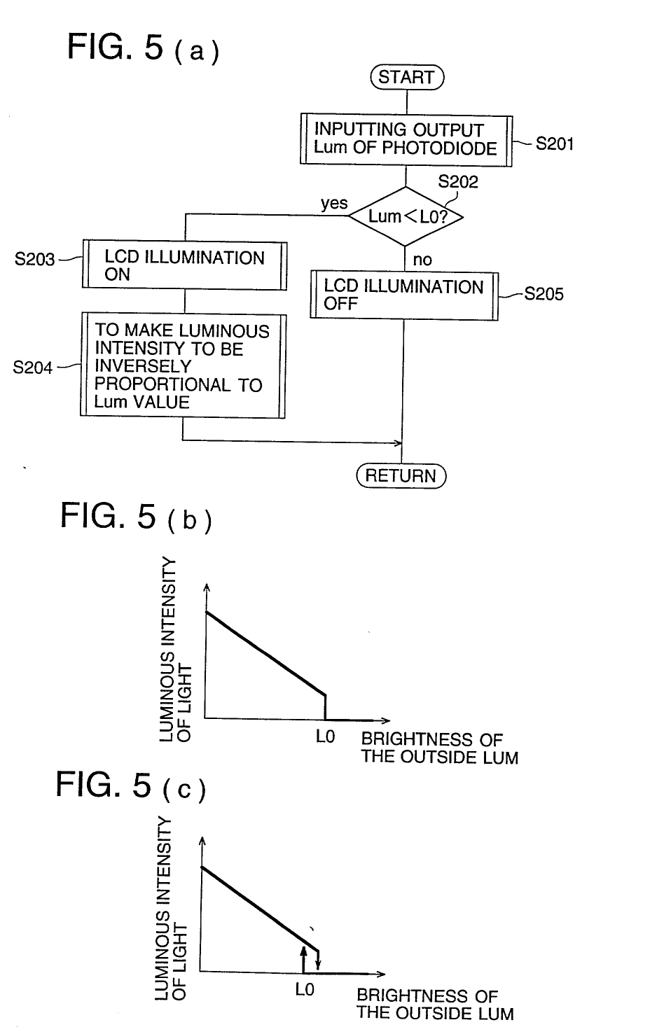

FIG. 5(a) is a flowchart showing operations of the variation. FIG. 5(b) is a graph showing luminous intensity of light 26 which is controlled based on the flowchart stated above for the measured brightness of the outside. A difference between the flowchart in FIG. 5(a) and that in FIG. 3 is that luminous intensity of light 26 is changed according to brightness of the outside, by transmitting control signals to light driving circuit 25 through D/A converter 27 in added step S211, before the subroutine is ended after energizing signals are transmitted to light driving apparatus 25 by CPU 24 in step S203.

In the present variation, in addition to the action effect in the first embodiment, it is possible to improve visibility of display on a liquid crystal monitor in a way wherein when the outside is still dim as in twilight, for example, though visibility of display on a liquid crystal monitor is lowered, CPU 24 judges this and starts illumination of light 26 to increase luminous intensity as the outside gets darker. Incidentally, as shown in FIG. 5(c), it is also possible to give hysteresis to the control. Since the method to give hysteresis is widely known, the details will not be described here.

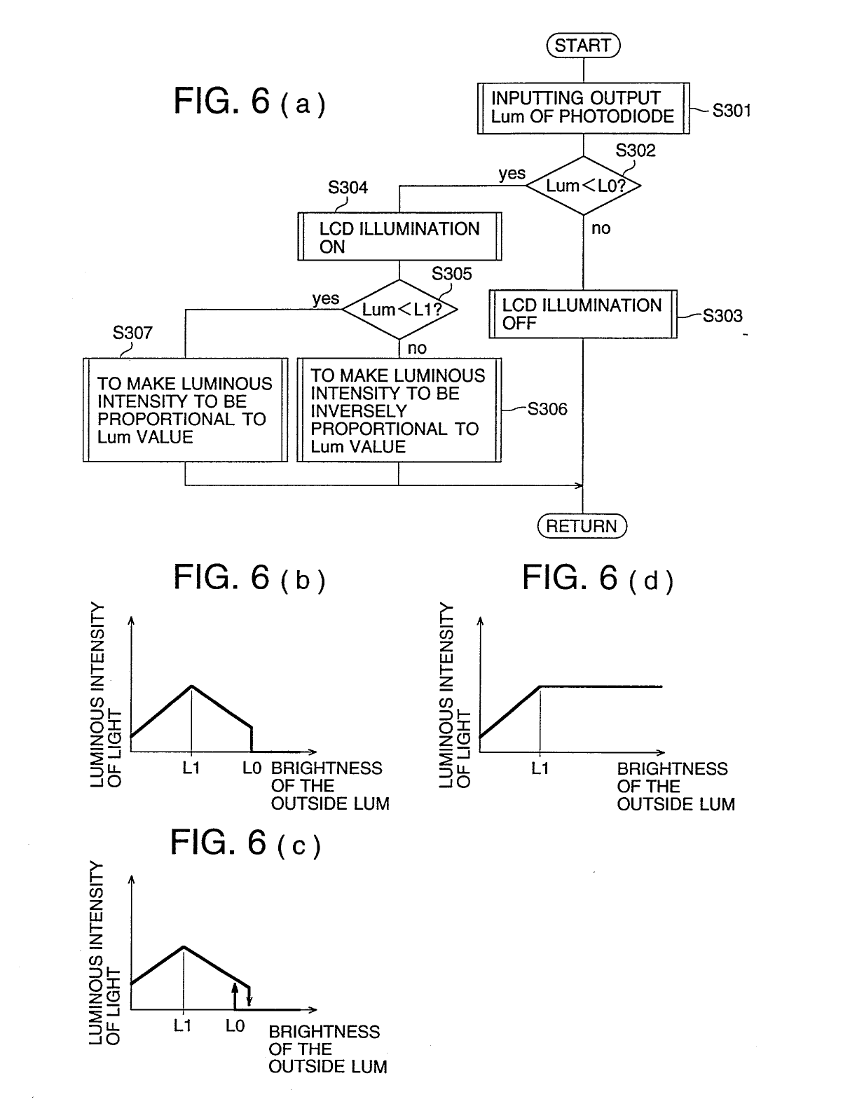

FIG. 6(a) is a flowchart showing operations of another variation in the case of structure shown in FIG. 4. FIG. 6(b) is a graph showing luminous intensity of light 26 which is controlled based on the flowchart stated above for the measured brightness of the outside. A difference between the flowchart in FIG. 6(a) and that in FIG. 5 is that a control mode is changed depending on whether brightness of the outside is lower than prescribed value (L1) or it is higher than prescribed value (L1).

To be more concrete, after starting lighting of light 26 in step S304, CPU 24 compares value Lum with prescribed value L1. When the value Lum is smaller than the prescribed value L1, CPU 24 adjusts luminous intensity of light 26 in proportion to brightness of the outside in step S307, and ends a subroutine. On the other hand, when the value Lum is the prescribed value L1 or more, CPU 24 adjusts luminous intensity of light 26 in inverse proportion to brightness of the outside in step S306 to end the subroutine.

When the outside is as dark as pitch as in the case of a moonless night, for example, visibility of display can be secured even when luminous intensity of light 26 is lowered to a certain extent. Therefore, in the variation shown in FIG. 6, when the outside is darker than prescribed value L1, it is possible to attain electric power saving by lowering luminous intensity of light 26 in proportion to brightness of the outside. Incidentally, it is necessary to make the control not to be discontinuous at prescribed value L1 in FIG. 6(c). Further, as shown in FIG. 6(c), it is also possible to give hysteresis to the control. Since the method to give hysteresis is widely known, the details will not be described here.

Further, the variation shown in FIG. 6 is applicable not only to the liquid crystal monitor which uses outside light such as a reflection type liquid crystal monitor and a daylight-backlight type liquid crystal monitor, but also to the liquid crystal monitor which does not use outside light but uses built-in lamp such as backlight type liquid crystal monitor. In other words, in the case that the backlight type, which does not use outside light but does only built-in light, is applied to the liquid crystal monitor, in the case that outside is dark in the darkness, visibility of the display is obtained if the luminance of the light is lowered to a prescribed value; therefore, CPU controls the luminance of the light so that the light as the built-in lamp is turned on if an image is displayed in the liquid crystal monitor but the outside luminance Lum is set to be smaller than the luminance of the light at L1 when the outside luminance Lum is not more than the luminance of L1. In this case, it is preferable that CPU controls the luminance of the light so that the outside luminance Lum is in proportion to the outside luminance when the luminance of the light is smaller than the luminance of L1.

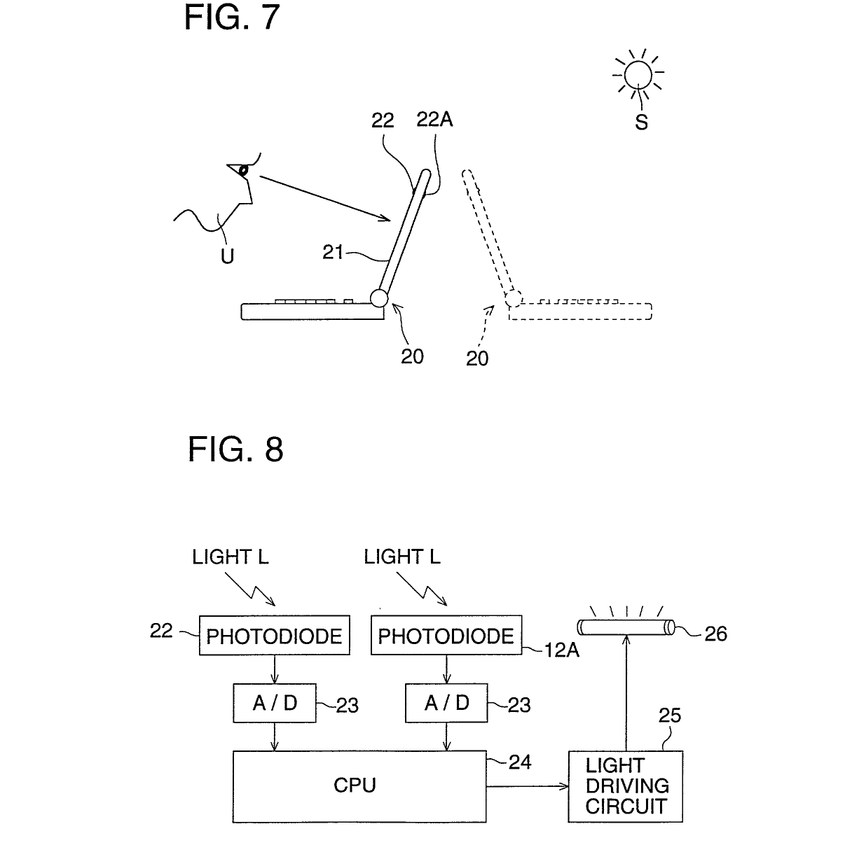

FIG. 7 is a diagram showing a laptop personal computer related to the second embodiment of the invention. A difference between the second embodiment and the first embodiment is that the personal computer is provided with two photodiodes. To be more concrete, in FIG. 7, personal computer 20 representing an image processing apparatus has reflection type liquid crystal monitor 21 for displaying images, and has first photodiode 22 on the plane on which the liquid crystal monitor 21 is formed, and has second photodiode 22A on a plane opposite to the plane where the liquid crystal monitor 21 is formed.

Incidentally, though an example of a reflection type liquid crystal monitor is explained in the present embodiment, the invention can be applied also to a liquid crystal monitor of a daylight-backlight type which uses outside light.

FIG. 8 is a diagram showing a control apparatus for a light in the personal computer shown in FIG. 7. In FIG. 8, light 26 is built in personal computer 20 to illuminate liquid crystal monitor 21 based on electric power supplied from light driving apparatus 25 at need (FIG. 7).

As shown in FIG. 7, photodiode 22 which receives outside light 1 on the side where user U observes liquid crystal monitor 21 outputs analog signals which are proportional to the intensity of the outside light to A/D converter 23. The A/D converter 23 converts the inputted analog signals into digital signals, and outputs them to CPU 24.

On the other hand, photodiode 22A which receives outside light 2 on the side opposite to that where user U observes liquid crystal monitor 21 outputs analog signals which are proportional to the intensity of the outside light to A/D converter 23A. The A/D converter 23A converts the inputted analog signals into digital signals, and outputs them to CPU 24. The CPU 24 is arranged to control light driving apparatus 25 through a mode explained below.

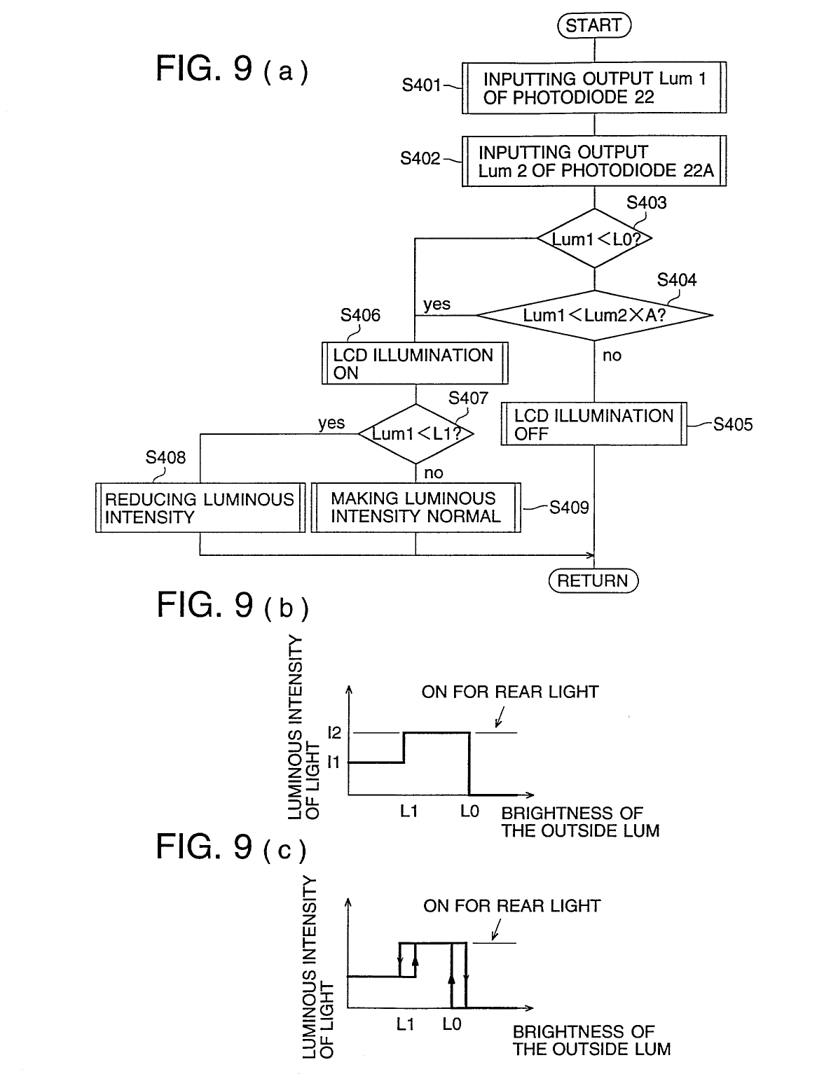

FIG. 9(a) is a flowchart showing control operations of CPU 24. FIG. 9(b) is a graph showing luminous intensity of light 26 which is controlled based on the flowchart stated above for the measured brightness of the outside. A flowchart shown in FIG. 9(a) also is executed periodically as a subroutine of CPU 24. When the subroutine is started, CPU 24 inputs output signal value Lum 1 from photodiode 22 first in step S401, and then, inputs output signal value Lum 2 from photodiode 22A in following step S402.

Further, CPU 24 compares-the output signal value Lum 1 with L0 representing a standard value in step S403. The standard value L0 is a value corresponding to the lowest brightness of the outside which makes it possible to view images displayed on liquid crystal monitor 21 without light 26.

When the output signal value Lum 1 is smaller than the standard value L0, CPU 24 judges that it is difficult to view liquid crystal monitor 21 because of the dark outside, and transmits energizing signals to light driving apparatus 25 in step S406 to turn light 26 on. Due to this, the liquid crystal monitor 21 is illuminated by light 16, and a user can view the displayed images easily. Further, in step S407, CPU 24 compares output signal value LUM 1 with prescribed value L1, and when CPU 24 judges that the output signal value LUM 1 is smaller than the prescribed value L1, CPU 24 sets the so-called light-attenuation mode wherein luminous intensity of light 26 is lowered to value I1 which is lower than value I2 in FIG. 9(b), in step S408. On the contrary, when CPU 24 judges that the output signal value LUM 1 is not less than the prescribed value L1, CPU 24 sets the so-called ordinary mode wherein luminous intensity of light 26 is maintained at value I2 in FIG. 9(b), in step S409. Incidentally, as shown in FIG. (c), it is also possible to give hysteresis to the control. Since the method to give hysteresis is widely known, the details will not be described here.

On the other hand, when the output signal value Lum 1 is not less than the standard value L0 in step S403, CPU 24 judges that the outside is bright. In the following step S 404, CPU 24 compares the output signal value Lum 1 with output signal value Lum 2 multiplied by value A. The value A is a value to correct the degree of rear light which is varied by the positional relationship between photodiode 22 and photodiode 22A. When an output value of photodiode 22A is higher than that of photodiode 22 in this case, the value of output signal value Lum 2 multiplied by value A is greater. Therefore, personal computer 20 is located to be in a position shown with solid lines against light source S shown in FIG. 7, and liquid crystal monitor 21 can be judged to be in the state of rear light. Therefore, CPU 24 judges that it is difficult to view liquid crystal monitor 21 because it is in the state of rear light although the outside is bright to a certain extent, and transmits energizing signals to light driving apparatus 25 in step S406 to turn on light 26.

On the contrary, when an output value of photodiode 22A is lower than that of photodiode 22, the value of output signal value Lum 2 multiplied by value A is smaller. Therefore, personal computer 20 is located to be in a position shown with dotted lines against light source S shown in FIG. 7, and liquid crystal monitor 21 can be judged to be in the state of front-light. In this case, CPU 24 does not turn on light 26. Incidentally, the value A is a value to adjust an extent of rear light, and when the value A is small, a light is not lit if the extent of rear light is not high enough. When the value A is great, on the other hand, a light is lit even when the extent of rear light is low. Value A of this kind is determined in accordance with an equipment equipped with a liquid crystal monitor.

As stated above, in the present embodiment, when liquid crystal monitor 21 of personal computer 20 is in the state of rear light, CPU 24 judges this based on output signals from two photodiodes 22 and 22A even when the outside is bright, and turns on light 26 automatically, thus, visibility of display on the liquid crystal monitor can be improved, in addition to the action effect of the embodiment stated above.

Further, it is possible to apply this embodiment, except the judgment whether the outside luminance Lum is smaller than L0 or not: the judgment whether light 26 is turned on or not, to a liquid crystal monitor of backlight type which does not use outside light but does only built-in lamp.

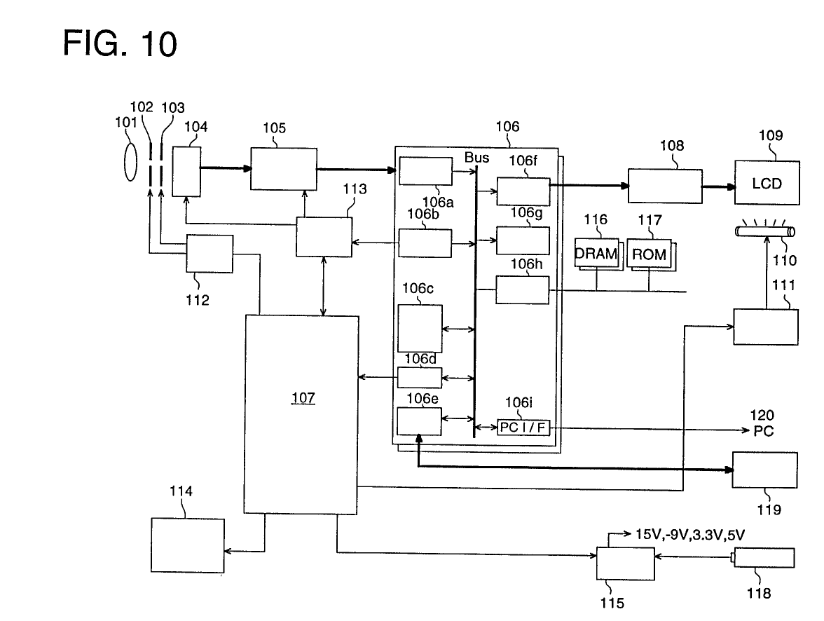

FIG. 10 is a block diagram showing the structure of a digital still camera serving as an image processing apparatus related to the third embodiment. In FIG. 10, CCD 104 on which an optical image is formed on a light-receiving surface by camera lens 101 through diaphragm 102 and shutter 103 can output analog signals corresponding to the optical image by conducting photoelectric conversion. The analog signals outputted from CCD 104 are converted into digital signals in A/D converter 105, and are inputted into CCD signal processing circuit 106a of main LSI 106.

The main LSI 106 has the structure wherein CCD signal processing unit 106a which conducts signal processing of CCD and outputs luminance signal Y and two color signals UV, unit 106b which outputs signals necessary for driving CCD, RISC microcomputer 106c which communicates with control of main LSI, AE operation and sub-CPU 107 so as to conduct file control, interface unit 106d which conducts serial communication with sub-CPU 107, control unit 106e of external flash memory 119, unit 106f which converts video data YUV into analog RGB signals and transmits them to LCD control circuit 108 to display images on LCD 109, unit 106g which converts video data YUV into JPEG image data, interface 106h which conducts communication with external memories (DRAM 116 and ROM 117) and interface unit 106i which conducts communication with external personal computer 120 are connected by bus Bus to be capable of communicating mutually.

Sub-CPU 107 is a microcomputer which is in charge of controlling a digital still camera, and it receives electric power supplied from built-in battery 118 through DC/DC converter 115 and controls diaphragm 102 and shutter 103 through diaphragm/shutter driving circuit 112 by cooperating with main LSI 106 in accordance with operation signals from switch group 14. Further, sub-CPU 107 controls CCD 104 and A/D converter 105 through timing generator 113, and it can further control light 110 which illuminates LCD 109 through light driving circuit 111.

With regard to operations in the present embodiment, when a power switch (not shown) of switch group 114 is pressed, sub-CPU 107 is awakened from the sleep state and makes DC/DC converter 115 to operate. RISC microcomputer 106c of main LSI 106 reads a program stored in ROM 117 to execute, and initial setting is conducted here.

In the case of image pickup, sub-CPU 107 drives diaphragm 102 and shutter 103 by controlling diaphragm/shutter driving circuit 112, and makes CCD 104 to take in images. Main LSI 106 processes signals from CCD 104 with signal processing circuit 106a, then, transmits them to LCD driving circuit 108 through unit 106f, and displays the so-called “through image” of an object on LCD 109.

RISC microcomputer 106c of main LSI 106 conducts automatic exposure control. Exposure control operations are conducted by adjusting an electronic shutter for diaphragm 102 and CCD 104 while keeping mechanical shutter 103 to be open. In this case, when a luminance value of an object calculated by an aperture value of diaphragm 102, electronic shutter speed and an output level of an image pickup element is lower than the prescribed value, main LSI 106 judges that the outside is dark, and notifies sub-CPU 107 that the outside is dark, by means of serial communication through RISC microcomputer 106c. In this case, sub-CPU 107 controls light driving circuit 111 to turn light 110 on.

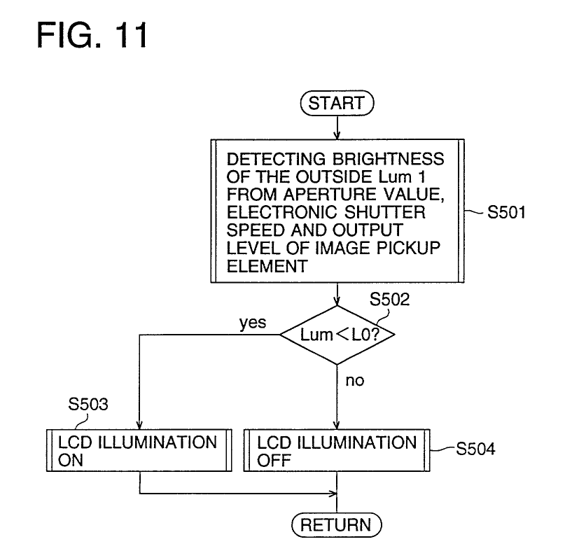

FIG. 11 is a diagram showing the flowchart which shows control operations of light driving circuit 111. A subroutine of this kind is executed periodically. First, sub-CPU 107 inputs a value which is obtained by integrating luminance of the total image plane, for example, from main LSI 106 in step S501, and uses that value, an aperture value and electronic shutter speed for calculation of outside brightness Lum 1. In the following step S502, the value Lum 1 is compared with L0, and when Lum 1 is smaller, sub-CPU 107 controls light driving circuit 111 to turn light 110 on (step S503). After that, the subroutine is ended.

When Lum 1 is not smaller than L0 in comparison between the value Lum 1 and L0, on the other hand, sub-CPU 107 controls light driving circuit 111 in step S504 to turn light 110 off. After that, the subroutine is ended. With regard to turning on/turning off of a light, it is preferable to give hysteresis in some modes as in the embodiment state above. Incidentally, it is also possible to keep light 110 on, by providing illumination-forcing switch and by turning it on. For example, when coming across the dark place suddenly under the reproduction mode, it is possible to improve visibility of display by turning on illumination-forcing switch to force the light to be lit.

Even in the case of image reproduction, the control of a light stated above is possible. To be concrete, sub-CPU 107 sets an aperture value of a diaphragm and electronic shutter speed respectively to their values determined in advance, and drives both CCD 104 and TG 113 to take in image data for several fields. When reproducing images, CCD 104 is used as a photometry (sensor) means for detecting brightness of the outside in the present embodiment, although it is not necessary originally to take in image data with CCD 104.

Main LSI 106 calculates external light from an output level of CCD 104, and when the external light is lower than the prescribed value, the main LSI 106 judges that the outside is dark, and notifies sub-CPU 107 that the outside is dark, by means of serial communication through RISC microcomputer 106c. In this case, the sub-CPU 107 controls light driving circuit 111 and turns on light 110. This action is conducted in the first place of image reproducing, or is conducted from time to time in the course of image reproducing.

Further, this embodiment and its variations described below can be applied as LCD to a display, which displays by using a built-in light as a illumination means, such as a reflection type liquid crystal monitor which uses outside light, daylight-backlight type liquid crystal monitor which uses outside light and backlight type liquid crystal monitor.

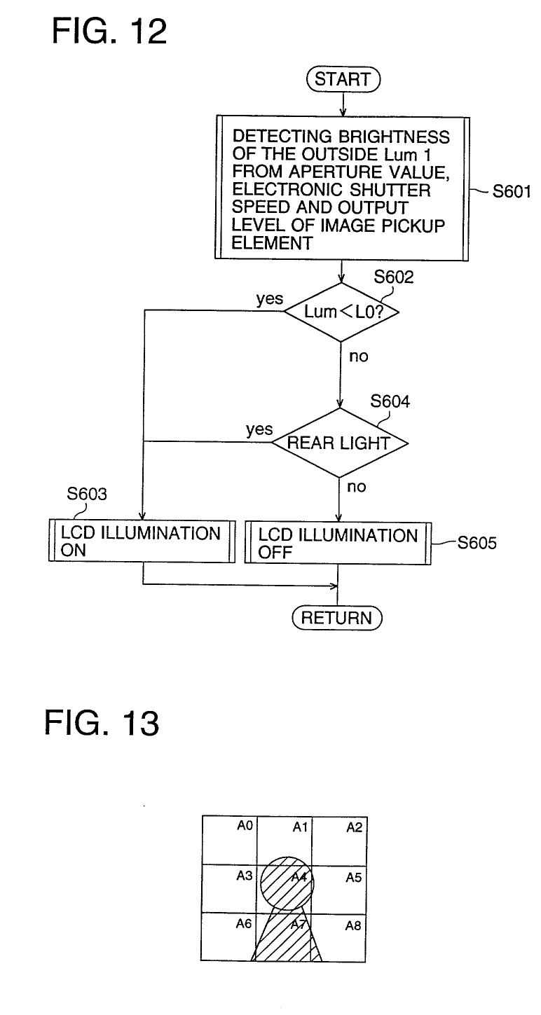

Further, in the variation described as follows, it is possible to improve visibility of LCD in the state of rear light. The following explanation is on the assumption that LCD representing a display of an ordinary digital camera is positioned to face the rear side of a camera (positioned to face a photographer) in the course of observation (photographing). In this case, an object and LCD are in the same state in terms of rear light or front light. FIG. 12 is a flowchart showing a variation of control operations of the light driving circuit 111, and FIG. 13 is a diagram showing an object which is subjected to image pickup by a digital camera together with an image plane, and it is a diagram for explaining judgment of rear light conducted in main LSI 106. During the display of images, subroutine shown in FIG. 12 is constantly executed based on image data obtained from an image pickup element. First, in step S601, sub-CPU 107 inputs value Lum 1 obtained by integrating luminance of a total image plane, for example, from main LSI 106. In the following step S602, value Lum 1 is compared with L0, and when Lum 1 is smaller, sub-CPU 107 controls light driving circuit 111 to turn light 110 on (step S603). After that, the subroutine is ended.

On the other hand, when Lum 1 is not smaller than L0 after they are compared, judgment is made whether an object is in the state of rear light or not. To be concrete, as shown in FIG. 12, an image plane is divided into 9 divisions of area A1 through area A9, and luminance of each area is detected. In this case, when a value of luminance of area A1 is lower than a mean value of luminance values of surrounding 8 areas, the object is judged to be in the state of rear light, while in the other case, the object is judged to be in the state of front-light. This calculation and judgment may also be conducted by main LSI 106 and the results may be transmitted to sub-CPU 107, or luminance data of areas A0-A9 may be transmitted to sub-CPU 107 to be judged by sub-CPU 107. It is preferable to give hysteresis also for turning on/turning off of light 110 in the state of rear light. Incidentally, a method of judgment of rear light is not limited to the foregoing.

If it is judged that an object is in the state of rear light, sub-CPU 107 controls light driving circuit 111 to turn light 110 on (step S603). After that, the subroutine is ended. If it is judged that an object is in the state of front-light, sub-CPU 107 controls light driving circuit 111 to turn light 110 off (step S605). After that, the subroutine is ended.

Next, there will be explained an occasion wherein relative positional relationship between CCD and LCD 109 representing a display means and relative positional relationship (direction) between an image pickup plane of CCD and a display plane of LCD 109 are variable. In this case, a position sensor which detects angle Θ formed between a space for image pickup by an image pickup element and a display space of a display means is provided, and a control means controls luminous intensity of an illumination means so that the following conditions, for example, are satisfied.

An illumination is turned on under the conditions of Θ≧270° and rear light for an object.

An illumination is turned off under the conditions of Θ≧270° and non-rear-light for an object.

An illumination is turned off under the conditions of Θ<270° and rear light for an object.

An illumination is turned on under the conditions of Θ<270° and non-rear-light for an object.

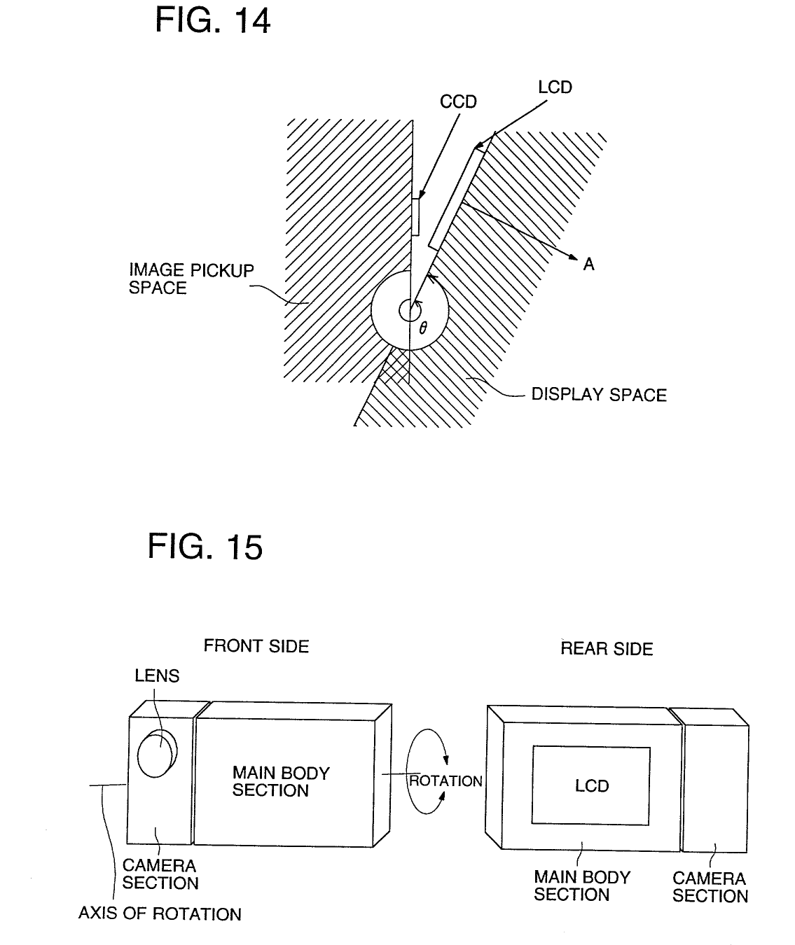

Incidentally, in FIG. 14, let it be assumed that a photographing direction (a direction from an image pickup element to an object along an optical axis direction) is one from the right side to the left side, and a display direction is one shown with arrow mark A.

By doing this, even in the case of changing positional relationship between CCD and LCD 109, it is possible to judge correctly whether an object is in the state of rear light or not, and it is possible to conduct image display appropriate for viewing.

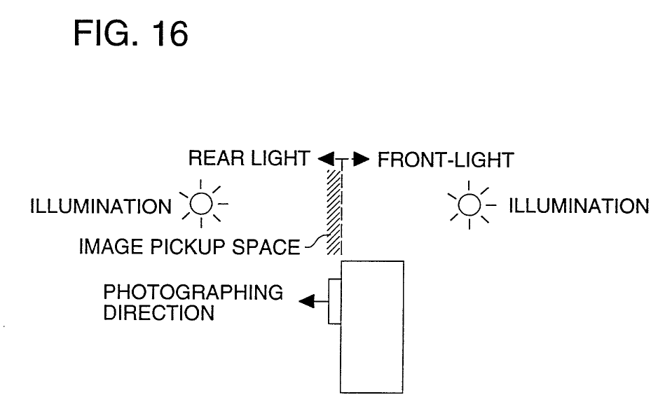

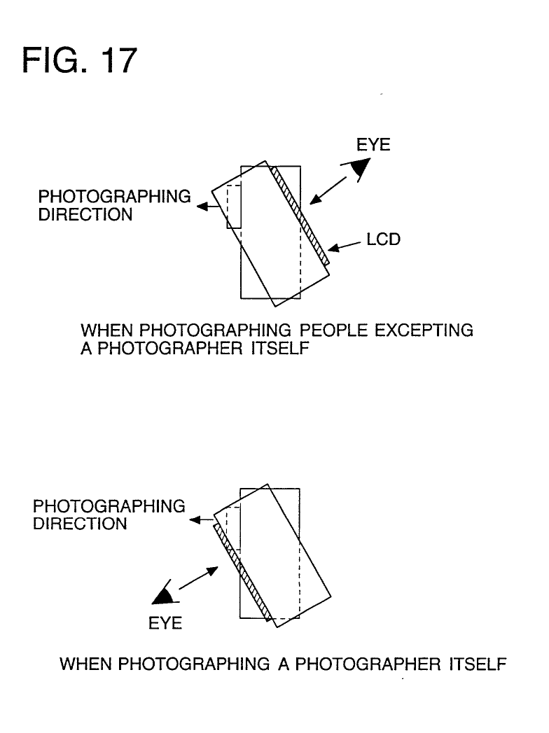

Next, as shown in FIG. 15, there will be explained concretely an example wherein an image pickup optical system (image pickup element) and a display means rotate on the same axis of rotation. FIG. 17 shows its concrete example. As shown in FIG. 16, in the control means, an illumination is judged to be rear light when it is positioned to be ahead of a camera and is judged to be front-light when it is positioned to be in the rear of a camera, in accordance with output signals from an image pickup element.

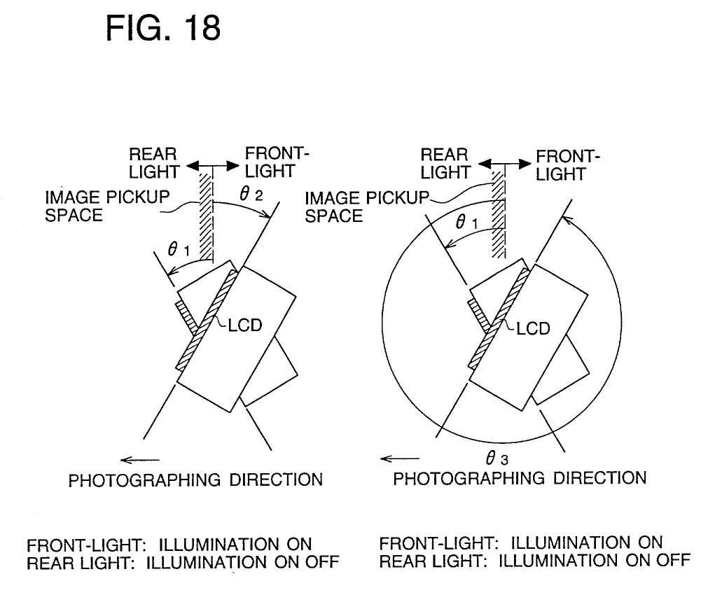

In the present example, as shown in FIG. 18, a control means obtains an angle formed between an image pickup space obtained based on the direction of a display plane of a display means detected by an unillustrated position sensor and a display space, and controls an illumination means so that an illumination may be turned on in the case of front-light and turned off in the case of rear light, when an angle formed between an image pickup space and a display space is any angle within a range of 0°-Θ1 or any angle within a range of 0°-Θ2. Further, when an angle formed between an image pickup space and a display space is outside the foregoing (namely, any angle within a range of Θ1-Θ3), an illumination means is controlled so that illumination is turned off in the case of front-light, and is turned on in the case of rear light. In this case, the photographing direction is assumed to be one from the right side to the left side in FIG. 18. Further, it is possible to design so that Θ1, Θ2 and Θ3 may take appropriate sizes.

Since brightness of the outside is detected by the use of CCD representing an image pickup element and it is possible to judge through image processing whether the state is in rear light or not in the present embodiment, it is possible to attain an object of security of display visibility on a liquid crystal monitor and an object of the control of power consumption which are contrary to each other, by controlling turning on/turning off of a light in accordance with circumstances.

In a summary of action effects in the embodiment stated above, it is possible to cut down power consumption by eliminating failure of turning off a light, because a light is turned off only in the case of darkness. Due to this, a battery can be made small in size, and a personal computer and a camera can be made small in size and light in weight. Further, under the circumstances where a liquid crystal monitor is hard to be viewed like rear light even when the outside is bright, a light is automatically lit, which makes it easy to use. Further, under pitch-dark circumstances, luminous intensity of a light is automatically lowered, which makes an image plane of the liquid crystal monitor not to be too bright.

Though the invention has been explained as stated above, referring to the embodiment, the invention is not limited to the embodiment, and it is naturally possible to make appropriate modifications and improvements on the invention. For example, a display apparatus of the invention may be provided either on a video camera or on PDA such as an electronic note. In this case, a light-receiving element can be used in place of CCD. Further, LCD can be of any type in reflection type, transmission type, daylight type and semi-transmission type.

What is claimed is:

1. A display apparatus, comprising:
an illumination means for irradiating;
a display being capable of displaying by using light irradiated by said illumination means;
a sensor for detecting brightness of the outside; and
a controller for controlling luminous intensity of said illumination means in accordance with the results of detection by said sensor.

2. The display apparatus of claim 1, wherein said controller controls said illumination means so as to irradiate when said controller judges that brightness of the outside is less than a first predetermined value in accordance with said results of detection by said sensor.

3. The display apparatus of claim 1, wherein said controller controls luminous intensity of said illumination means so that said luminous intensity of said illumination means is inversely proportional to brightness of the outside when said controller judges that brightness of the outside is less than a first predetermined value in accordance with said results of detection by said sensor.

4. The display apparatus of claim 1, wherein said controller controls luminous intensity of said illumination means so that said luminous intensity of said illumination means is lower than that in a condition where brightness of the outside is a second predetermined value when said controller judges that brightness of the outside is less than said second predetermined value in accordance with said results of detection by said sensor.

5. The display apparatus of claim 1, wherein said controller has a first photometric sensor and a second photometric sensor which is provided at a position that is physically different from that of said first photometric sensor; and said controller controls luminous intensity of said illumination means in accordance with results of photometry by said first and second photometric sensors.

6. The display apparatus of claim 1, wherein said sensor is an image pickup element.

7. The display apparatus of claim 6, wherein said controller judges whether an object which is subjected to image pickup by said image pickup element is in a state of rear light or not, in accordance with output signals form said image pickup element, and said controller controls said illumination means so as to irradiate when said controller judges that said object is in said state of rear light.

8. The display apparatus of claim 6, wherein said controller controls luminous intensity of said illumination means so that said luminous intensity of said illumination means is lower than that in a condition where brightness of the outside is a predetermined value when said controller judges that brightness of the outside is less than said predetermined value in accordance with said results of detection by said sensor.

9. The display apparatus of claim 5, wherein said controller judges whether said display is in a state of rear light or not, in accordance with detection results of said first and second photometric sensors, and said controller controls said illumination means so as to irradiate when said controller judges that said display is in said state of rear light.

10. The display apparatus of claim 1, wherein said display is a liquid crystal display which is capable of displaying by using light of the outside.

11. The display apparatus of claim 7, further comprising a position sensor for detecting a positional relationship between said image pickup element and said display;
wherein said controller judges whether an object which is subjected to image pickup by said image pickup element is in said state of rear light or not, in accordance with detection results of said position sensor and said image pickup element; and said controller controls said illumination means so as to irradiate when said controller judges that said object is in said state of rear light.

12. An image processing apparatus, comprising:
an image pickup element for obtaining image data by transforming optical information into electric signals;
a setting means for setting exposure conditions;
a memory for storeing image data obtained from said image pickup element;
an illumination means for irradiating;
a display being capable of displaying an image corresponding to image data obtained directly from said image pickup element or stored in said memory by using light irradiated by said illumination means; and
a controller for controlling luminous intensity of said illumination means by judging a state of the outside in accordance with image data obtained from said image pickup element and said exposure conditions established by said setting means.

13. The image processing apparatus of claim 12, wherein said controller controls luminous intensity of said illumination means by obtaining image data from said image pickup element when said display means displays an image corresponding to image data stored in said memory.

14. The image processing apparatus of claim 12, wherein said display is a liquid crystal display which is capable of displaying by using light of the outside.

15. The image processing apparatus of claim 12, further comprising a position sensor for detecting a positional relationship between said image pickup element and said display;
wherein said controller judges whether an object which is subjected to image pickup by said image pickup element is in a state of rear light or not, in accordance with detection results of said position sensor and said image pickup element; and said controller controls said illumination means so as to irradiate when said controller judges that said object is in said state of rear light.

16. The display apparatus of claim 3, wherein said controller controls luminous intensity of said illumination means so that said luminous intensity of said illumination means is proportional to brightness of the outside when said controller judges that brightness of the outside is less than a second predetermined value in accordance with said results of detection by said sensor, said second predetermined value being less than said first predetermined value.

17. The display apparatus of claim 1, wherein said controller controls said illumination means so as to irradiate when said display is in a state of rear light.

18. The display apparatus of claim 10, wherein said display has guide means for guiding light of the outside to a liquid crystal of said display or reflecting means for reflecting light of the outside and guide to said liquid crystal of said display.

19. The display apparatus of claim 2, wherein said display is a liquid crystal display which is capable of displaying by using light of the outside.

20. The display apparatus of claim 19, wherein said display has guide means for guiding light of the outside to a liquid crystal of said display or reflecting means for reflecting light of the outside and guide to said liquid crystal of said display.

21. The display apparatus of claim 6, wherein said controller controls luminous intensity of said illumination means so that said luminous intensity of said illumination means is inversely proportional to brightness of the outside when said controller judges that brightness of the outside is less than a first predetermined value in accordance with said results of detection by said image pickup element.

22. The display apparatus of claim 21, wherein said controller controls luminous intensity of said illumination means so that said luminous intensity of said illumination means is proportional to brightness of the outside when said controller judges that brightness of the outside is less than a second predetermined value in accordance with said results of detection by said image pickup element, said second predetermined value being less than said first predetermined value.

23. The display apparatus of claim 1, wherein said controller controls luminous intensity of said illumination means so that said luminous intensity of said illumination means is proportional to brightness of the outside when said controller judges that brightness of the outside is less than a second predetermined value in accordance with said results of detection by said sensor.

24. The image processing apparatus of claim 14, wherein said display has guide means for guiding light of the outside to a liquid crystal of said display or reflecting means for reflecting light of the outside and guide to said liquid crystal of said display.
